(19) United States
(12) Patent Application Publication
(10) Pub. No.: US 2022/0284400 A1
(43) Pub. Date: Sep. 8, 2022

(54) UNATTENDED EMPLOYMENT MATCHING AND HIRING SYSTEM WITH SIMPLIFIED CANDIDATE ACCEPTANCE

(71) Applicants: Katherine B. Hutton, San Diego, CA (US); Ryan W. Volberg, Port Moody (CA)

(72) Inventors: Katherine B. Hutton, San Diego, CA (US); Ryan W. Volberg, Port Moody (CA)

(21) Appl. No.: 17/230,881

(22) Filed: Apr. 14, 2021

(30) Foreign Application Priority Data
Mar. 8, 2021 (CA) 3111524

(51) Int. Cl. G06Q 10/10; G06F 16/9535

(52) U.S. Cl. CPC G06Q 10/1053; G06F 16/9535

(57) ABSTRACT

A system and method for facilitating offering and filling of employment positions by employers, administered without employer intervention from the completion of job listing to the onboarding of a completed hire. Job candidates are matched by hiring criteria with available positions, and can accept an offered position through an electronic interface. The electronic interface would facilitate the unattended acceptance of offered positions by way of a simplified or single user interface interaction.

### CROSS-REFERENCE TO RELATED APPLICATION(S)

This application claims priority to Canadian Patent Application No. 3,111,524 filed on Mar. 8, 2021, the content of which is herein incorporated by reference in its entirety.

### FIELD OF THE INVENTION

This invention is in the filed of automated business systems and more particularly discloses an automated hiring system used to match and offer/select employees for job hiring without the need for employer intervention or participation in the hiring process.

### BACKGROUND

Many industries have benefitted from significant speed and quality enhancements in their business processes from the deployment of software based and machine learning systems in certain business functions. These systems allow for significantly improved outcomes and optimized workflows across virtually any aspect of a business.

One of the areas in which businesses invest a great deal of time and effort is in the hiring process—ensuring the hiring of compatible employees for different jobs in organizations can in many cases be a full-time function for a number of employees or entire departments in organizations, and if it were possible to provide enhanced tools for use in this business function it is believed that many businesses of all sizes could benefit.

The effort required to maintain a full employee roster is particularly difficult in companies having high turnover in certain job categories. For example, in the hospitality industry and other areas, some companies can have over 100% turnover in their employee roster on an annual basis—if it were possible to provide tools and systems to enhance the hiring outcomes for these companies, these tools would enjoy commercial acceptance and success.

In the case of high-turnover, typically hourly, job categories—there is typically far less subjective consideration that goes into hiring, and job candidates can be selected by and large on the basis of availability, since much if not all of the training for the position is provided by the employer. If it were possible to provide an electronic system which would automate the hiring process, and optimally remove or minimize the need for human intervention by the employer it is believed that this would provide a substantial improvement over current state-of-the-art and be widely accepted.

The overarching concept of the present invention is to provide a system that permitted for criteria based matching of job candidates against available jobs of one or more employers wherein a sufficient level of certainty in the computer-based matching process could be reached to remove the need for the conduct of interviews or human intervention in the hiring process. The desire is to provide a system that would permit an employer to post a job that needed to be filled, and the remainder of the process including the conduct of criteria matching of positions against available candidates could be done using an automated process resulting in the automated offering of the job. Further layers could be added to the criteria matching process—for example personality trait matching could be incorporated to provide a higher level of cultural fit certainty in the matching algorithm as well.

If it were possible to also provide a system that would not only provide a sufficient level of compatibility certainty to employers to permit them to accept an automated hiring process particularly in high turnover roles, but also would allow a candidate having the criteria to match a particular role to accept a job through user interface interaction with a mobile device or web interface interacting with a server of the method of the present invention without the need for an interview or direct communication to take place, this would further accelerate the marketplace viability of the system and method of the present invention. Effectively, a hiring system that provided a sufficient level of hiring certainty to the employer to trust the decision being made by the system to allow the system to offer the job and have it accepted by the candidate without human intervention from the employer side—effectively permitting an unattended job offer process to qualified candidates permitting a candidate to accept a position by a simple user interface interaction such as a swipe or selection on a human interface screen etc.—is the ultimate goal here.

### SUMMARY OF THE INVENTION

As outlined above and herein, it is the overall intention of the present invention to provide a computer implemented automated hiring method whereby employers can automate the hiring of compatible candidates for available jobs providing a matching engine that would permit the offering of jobs to candidates without employer intervention—in its broadest sense, effectively a “swipe to hire” system.

In a first embodiment the invention discloses a computer implemented automated hiring method whereby employers can automate the hiring of compatible candidates for available jobs. The first component of the system is a server, having a processor and a memory and a network interface capable of communication with the client devices of employers and candidates by a wide area network.

The system also comprises an employer database comprising an employer record for each employer using the method. The employer records will include employer identifying information, authentication or credentials or the like.

In addition to the employer database, the server would also host or have access to a job database which comprises a job record corresponding to each job sought to be filled by an employer in accordance with the method. Each job record would include a connection to a related employer record in the employer database, along with at least one job selection criteria for the job. Job selection criteria are selection criteria which successful candidates for the corresponding job must possess in order to be qualified for selection by the employer. These for example might be particular skills, physical attributes or the like that comprise base requirements for the position, for example, being able to lift twenty-five pounds, having first aid training etc. In addition to the selection criteria including successful candidate-based criteria, the job selection criteria might include employer-based or location based criteria which need to be matched—for example an employer with multiple work locations might include as a criteria the location at which a particular job is located which must be matched by a successful candidate as being a location where they would be interested to work etc.

Each job record in addition to including any identifying information and job selection criteria for the related job would also include an indication of any post-hiring conditions which would need to be required to be verified in respect of the successful candidate, following the acceptance of the automatically offered job in accordance with the method. There may or may not be post-hiring conditions to be met although in many cases there may be verification steps or the like which need to be conducted by the HR personnel of the employer etc.—for example a criminal record check, verification of the currency or completeness of the particular licenses, skills or certifications etc. Clearance of post-hiring conditions following an automatic hiring in accordance with the remainder of the method is the only area in which there may be required HR follow-up by the employer, following the offer and acceptance of the position and in advance of the commencement of employment.

Each job record in the job database will also include a job status indicator indicating the open or completed status of hiring for the job. Effectively, once a particular job corresponding to a job record is offered and accepted by a particular successful candidate, the job record corresponding to that job would be “deactivated” in the job database by altering the job status indicator from open to completed.

Additionally, the system would also include a candidate database which comprises a candidate record corresponding to each candidate seeking employment, and which can be used for matching and hiring in accordance with the remainder of the method. Each candidate record would include identifying information of the candidate, as well as candidate selection criteria. The candidate selection criteria are selection qualifications possessed by the candidate which can be matched against the job selection criteria in the job database to provide a job matching the first level degree of certainty between a particular position at a particular potential employee, based upon their qualifications, traits and skills, certifications etc. as well as satisfying any other employer criteria such as location and the like.

Each candidate record would also include a candidate status indicator indicating the available or hired status of the related candidate—effectively once the candidate accepts a position offered to them in accordance with the remainder of the method of the present invention the candidate record could be “deactivated” so as to not be considered in additional matching operations on the database by updating the candidate status indicator from available to hired. In certain embodiments, the candidate could provide information to the system for storage and their corresponding candidate record indicating that they wish to remain available for offer of additional positions, to accommodate situations where candidates may work multiple jobs. Both such approaches are contemplated within the scope of the present invention.

The system would also include a hiring software component operable on the server and capable of executing the steps of the method. Specifics and variations on the construction or behaviour of the hiring software component will be understood to vary and any hiring software components which will achieve the desired outcome of executing the steps of the method as outlined are contemplated within the scope of the present invention.

In this first embodiment the system would execute a method comprising the creation and administration of records in the various databases in the system as well as conducting matching and hiring operations as outlined.

An employer having a profile on the system could create job records for available jobs for whom a candidate is desired to be hired. When a job record is required to be created, the server will interact with an employer client device to capture job data from the employer including at least job identifying information, employer identifying information by which the job record can be associated with the employer and their link to employer record, as well as any job selection criteria of the job. The server will then create a job record using the captured job data, including setting the job status indicator of the job record to open to indicate the associated jobs available for hiring.

A job candidate seeking to participate in the matching system and method of the present invention for the purpose of being hired could, using a client device in communication with the server, create a candidate record in the candidate database by transmitting candidate data to the server including at least candidate identifying information and candidate selection criteria of the candidate. The server would then create a candidate record using the captured candidate data, including setting the candidate status indicator of the created candidate record to indicate the associate candidate is available for hiring. The candidate record would be used for assessment of the compatibility of the candidate against available jobs on offer from multiple employers on the system.

The system and the hiring software component would also facilitate a matching step in the method upon the detection of the existence of a scan condition in respect of the selected candidate record having an available status employment indicator. A scan condition would effectively be any database or environmental condition which should trigger the conduct of a matching pass through the databases to determine whether or not there are any available jobs to be offered to the candidate. The scan condition could be a periodic time frequency, a manual trigger by the candidate or a manual trigger of scanning of the entire database structure by the employer in question, or any other type of a condition which would initiate the matching step. Certain embodiments of the invention could be created in which either an employer or a candidate could manually trigger the existence of a scan condition—in some embodiments of the system and method of the present invention the manual triggering of a scan condition could be a premium feature which could be provided to either a candidate or an employer at a higher fee. Any type of a scan condition of this nature is contemplated to be within the scope of the present invention.

On the detection of the existence of the scan condition, the matching step would be conducted by the system. The matching step comprises first selecting any job records with an open status, being open job records from the job database.

Following the selection of a subset of open job records from the job database, the hiring software component would then match the selected candidate record against any open job records by seeking to match the candidate selection criteria of the selected candidate record with the job selection criteria of each open job record. Depending upon the nature of the system and the desires of particular employers, this matching process could require a complete match between all criteria between the candidate and the job, or could be configured to permit the matching of a candidate record with a particular job record if the candidate selection criteria and the job selection criteria were similar enough to be within a configurable or selectable threshold. Both such approaches are contemplated within the present invention. Any open job records for which a match exists with the selected candidate record are matched job records.

Continuing in the matching step if there is at least one matched job record, the system of the present invention would facilitate an offer, being an unattended offer of employment of any of the matched jobs corresponding to the matched job records, to the selected candidate. The offer step would be conducted by presenting to a user interface of a candidate client device the details of the matched jobs. The candidate would be permitted to accept one of the matched jobs displayed corresponding to a matched job record by a user interface interaction by the interface of the candidate client device.

Effectively this interface display of available matched job records and the potential to accept one of the matched jobs comprises the offer and acceptance of the related job being facilitated without human intervention by the employer.

It is explicitly contemplates that the user interface interaction by which a candidate could accept a job in accordance with the length of the present invention would be a simple or single user interface interaction and for example the touch interface of a mobile device etc. For example, the system could permit the candidate to swipe or click on a matched job to accept the job. A single user interface interaction of this nature, or otherwise presenting the details of the matched jobs and permitting a straightforward process by which the candidate can use the user interface of the candidate device in question to indicate acceptance of an offered position will all be understood to be within the scope of the present invention.

If the candidate accepts a job in the user interface interaction, the job status indicator of the corresponding job record would be updated to indicate that the job is no longer available for hiring, and the candidate status indicator of the corresponding can be updated to hired status, indicating that the selected candidate is no longer seeking employment. This would effectively withdraw the accepted job from the inventory of available positions for matching, and optionally could withdraw the candidate from the pool of available candidates for positions depending on whether or not they wish to be matched to any additional jobs.

A user interface confirmation communication could be provided to the candidate by their candidate client device confirming acceptance of the job subject only to the validation of post-hiring conditions outlined in the corresponding job record, and the details of the corresponding candidate record and job acceptance would be transmitted to the corresponding employer for the completion of confirmation of post-hiring conditions if any and the initiation of the employment relationship.

Keys to the method of the present invention include the fact that the hiring of employees in accordance with the method takes place without user interaction or intervention on the part of the employer during the hiring process, following the establishment of the necessary database records, and the acceptance of a matched job by a candidate in accordance with the method is subject only to validation of the prescribed post-hiring conditions by the employer and the user interface interaction itself in which a position is accepted in all respects constitutes the formal receipt and acceptance of an offer of employment subject only to those post-hiring conditions.

Different types of user interface interactions will be understood to those skilled in the art of software interface design, depending to a degree upon the nature of the software used that the client and to interact with the server of the present invention as well as the type of client device. Considering that the client device being used would in most circumstances probably comprise a smart device, such as a mobile telephone, tablet or the like, a single touch interface interaction such as a swiping motion or the like on the job desired to be accepted could comprise the user interface interaction, or in other designs, selecting the desired job to be accepted, if any, on the interface of the client device and then making a confirmatory indication of acceptance are a couple of options. A confirmation indication of acceptance could be a single interface click on the interface of the candidate client device, or the like. Any type of an interface interaction permitting the streamlined indication by a candidate of the acceptance of an offered position will be understood to be within the scope of the present invention.

Many types of candidate selection criteria could be stored in the candidate record for the exercise of the method of the present invention. These could include candidate selection criteria selected from the group of desired location of employment, physical or mental attributes or skills of the candidate for consideration in hiring for a particular type of job or position, or certifications or licenses held by the candidate etc. The types of candidate selection criteria which could be used in the present invention will be understood to those skilled in the art to be virtually limitless and any type of candidate selection criteria is contemplated within the scope of the present invention.

Similarly, the job selection criteria stored in a particular job record could also be of infinite types without departing from the intended scope hereof. The job selection criteria could be selected from the group of employer location, physical or mental skill requirements of the successful candidate for a job, or certification or licensing requirements or the like of the successful candidate. It will be understood that any type of a job selection criteria as will be understood to those skilled in the art of hiring are all contemplated within the scope of the present invention.

Inclusion of post-hiring conditions required to be verified in respect of the successful candidate in a particular job record is optional. There may be certain cases in which there are no post-hiring conditions to be met and other cases in which there are a number of post-hiring conditions required to be verified. Inclusion of post-hiring conditions provides the only post-acceptance qualifier to the completely automated acceptance of a position by a candidate. Allowing employers to include post-hiring conditions in a job record will allow for the creation of sufficient certainty and comfort in the operability of the system for employers to accept its use. Post-hiring conditions could be infinite in nature although it is primarily contemplated that they would comprise quick verification for example of a successful completion of a criminal record check, verification of the current status of training or certifications and qualifications or the like. It will be understood that any type of a contingency as will be understood to those skilled in the art of hiring as potentially being verified post offer and acceptance of the position are understood to be within the scope of the present invention.

Additional embodiments of the present invention are possible which could provide even a higher level of comfort or certainty in terms of candidate compatibility for employers, to cause them to accept the automated or noninterventionist method of the present invention. For example, in certain embodiments of the system, the employee information stored by the employee management system of an employer includes employee information of existing or past employees which included job category indicator and job performance data for each existing or past employee. Various types of job performance data will be stored in these employee management systems, including for example the length of employment which is seen as one key indicator of personality compatibility and indicator of employee success—if employees remain employed in the same role or with the same employer for a longer period of time there is obviously a compatibility of personality with the roles they are working in and the employer work culture. Job performance data including the length of tenure of employees as well as other attributes or performance data will be understood to be useful in the personality/behavioural profiling outlined herein which is intended to provide a higher level of certainty in the qualification of candidates and all such job performance data are contemplated to be within the scope of the present invention. Using performance data and other information of existing or previous employees of an employer to generate a an employee success index or a personality or culture profile of successful employees of the employer against which additional personality or cultural traits of candidates could be captured in candidate records for matching purposes will all be understood to be within the scope of the present invention.

In embodiments of the system and method of the present invention that include the personality matching for employers and candidates outlined above, the matching step would further comprise the conduct of a profile matching step in respect of any matched job record following the determination of the existence of any matched job records, where the software would compare the candidate compatibility index stored with a selected candidate record to the employee success index of the related mapped system job category stored in association with the employer record matched to the matched job record. If the candidate compatibility index does not meet a desired configurable threshold equivalence with the employee success index of the employer, the matched job record would no longer be considered a matched job record, and conversely if it is determined that there is a threshold equivalence between the candidate and the job based on the comparison of these indexes for the employer and the candidate yielding a confirmed matched job record, the corresponding job can be offered. Embodiments of this nature will ensure the threshold level of personality compatibility between the selected candidate and any jobs to be offered corresponding to the matched job records.

In embodiments such as this, where matched job records are verified to be jobs for which a particular selected candidate is qualified not only based on job criteria but also in behavioural or personality matching, the highest threshold of certainty and matching is achieved which can permit employer confidence in trusting the automated hiring method.

It is specifically contemplated that the system and method of the present invention will be offered by a client/server Internet-based system. The network could be the Internet, and the server could be a Web server capable of communication with mobile or remote client devices operatively connected to the network and capable of communicating with the server via a web interface or other software served or engaged in communication therewith or therefrom.

It is specifically contemplated that the system and method of the present invention would be offered on behalf of a plurality of employers i.e. the number of employer records would be more than one, resulting in the ability to offer a service bureau to multiple employers and the ability for job candidates to be considered for jobs with multiple employers at the same time through a single registration and profiling process.

In addition to the method of the present invention and the various embodiments outlined above providing a computer implemented hiring method for employees, the invention also comprises the system to be used to facilitate the various embodiments of the method.

Overall it will be understood that the system and method of the present invention will permit the unattended hiring of candidates for selected posted jobs of employers, through a simple and straightforward user interaction process with the interface of a client device of the job candidate and in many embodiments of the method including a high level of certainty for the employer based upon a personality matching system matching the traits of candidates with the traits of successful existing or former employees of the employer. The system and method of the present invention will also succeed in offering a streamlined candidate matching and hiring system which removes any potential for discrimination bias from the hiring process.

### DESCRIPTION OF THE DRAWINGS

To easily identify the discussion of any particular element or act, the most significant digit or digits in a reference number refer to the figure number in which that element is first introduced. The drawings enclosed are:

FIG. 1 is a schematic diagram of one embodiment of the system of the present invention including client devices for demonstrative purposes;

FIG. 2 is a block diagram demonstrating one embodiment of basic data structures of the databases of the system of FIG. 1.

FIG. 3 is a block diagram demonstrating the key components of one embodiment of the server in accordance with the present invention;

FIG. 4 comprises a flowchart demonstrating the steps of the first embodiment of the method of the present invention;

FIG. 5 is a flowchart showing the steps in one embodiment of a job record creation subroutine of FIG. 4;

FIG. 6 is a flowchart showing the steps in one embodiment of the candidate record creation subroutine of FIG. 4;

FIG. 7 is a flowchart showing the steps in one embodiment of the candidate matching subroutine of FIG. 4;

FIG. 8 is a sample mockup of the screen which could be shown to a candidate in the process of a scanned step and the offering of a job, through which a user interface interaction could take place; and

FIG. 9 is a sample mockup of the screen demonstrating a confirmation of an accepted position for a candidate.

### DETAILED DESCRIPTION OF ILLUSTRATED EMBODIMENTS

As outlined herein, the present invention comprises a system and method for use in the hiring of employees through an electronic system negating the need for human intervention of employers in the hiring process from the time of listing the job to the time of acceptance thereof.

There are a number of entities to be considered in understanding the operation and efficacy of the method of the present invention.

Employers have employees, each of whom inhabits a job. Filling empty jobs is the primary intention of the system of the present invention. Different types of jobs, within the overarching scope of the categories of jobs for which the method would be effective, can be classified into different categories. For example, in a restaurant there might be waiters, cooks, dishwashers or the like. In a grocery store there might be shelf stocking personnel, cashiers etc. A particular employer might have one or more than one employee within each employer level job category. An employer seeking to match a single job to a candidate or a large number of jobs to a larger number of candidates would be equally as able to benefit from the time optimization of the system outlined.

A job candidate is an individual seeking employment and seeking to be matched with a job that might be offered in the system of the present invention.

While the system and method of the present invention could be practised on behalf of a single employer i.e. it could be used to catalogue and offer jobs only with one employer at one or more locations for example, it is explicitly contemplated that the more effective embodiments of the system of the present invention would be offered in behalf of a plurality of employers. I.e. job candidates seeking jobs could be matched by the system with available positions of multiple employers, which would make the system and method more desirable to candidates and could thus generate a larger pool of candidates for matching purposes on behalf of all of the employers. Offering the system and method of the present invention to multiple employers in a single system, on this basis such that available jobs of multiple employers could be matched to candidates creating a candidate record in a single system, is explicitly contemplated within the scope of the present invention.

Job Selection Criteria:

Each job of an employer would have at least one job selection criteria associated with it. These would be hiring criteria for potential employees, or other employer level criteria which might apply to the position. For example a job selection criteria might be the actual employer location at which the employment would be located. Job selection criteria might also include physical or mental skills or attributes of a successful employee which might be required for the particular nature of the position. For example a dockworker might need to be able to lift a certain amount of weight or something like that which could be a job selection criteria. Other job selection criteria might include particular licenses, training or certifications that needed to be held by a successful candidate. Any type of a personal attribute or a job or employer level attribute which could be used for the purpose a first stage match of an available job candidate to the position would be within the scope of job selection criteria as described in intended.

Post-Hiring Conditions:

Certain jobs might also have post-hiring conditions associated with them. Post-hiring conditions, for the purpose of the remainder of this document, are conditions or contingencies which might need to be cleared following the acceptance of the job to confirm the entitlement or ability of the employee to start work. For example, a job might be accepted subject to the condition that the candidate needs to pass a criminal record check, identity verification, confirm the current state of particular licenses or training etc. and that the job offered is offered on the condition that those post-hiring conditions would be cleared in order for the employee to start work.

Candidate Selection Criteria:

Each candidate has candidate selection criteria associated with them which would be stored in candidate records corresponding to the candidates in accordance with the remainder of the method. For example, candidate selection criteria might include the amenability of a candidate to work in particular locations, their physical or mental training or ability in terms of particular jobs i.e. in the example of a dockworker outlined above, that they can they lift 50 pounds or more. Other candidate selection criteria might include the fact that the candidate holds particular training, licenses or certifications etc. Any type of a selection criteria which could be used to match a candidate to a particular available job are contemplated to be candidate selection criteria as outlined.

Employee Success Index:

For embodiments of the system and method of the present invention that include a behavioural/personality matching element to increase the level of certainty in matching as well as the level of competence of employers in the success outcomes to be afforded by the system, an employee success index would be calculated in accordance with the remainder of the invention and stored in respect of an employer, or each system-level job category in which the employer has positions listed for filling and matching. The employee success index is specifically contemplated to be a quantitative measure, or plurality of measures, which could be used for matching purposes and which would effectively represent the desirable personality traits of successful employees of the employer. As will be disclosed elsewhere herein, the employee success index or indexes could be the result of direct calculations applied to personality assessment outcomes of previous and successful employees of the employer, or could be rendered using an artificial intelligence or machine learning component or function.

Compatibility Indices:

A personality assessment for successful employees could be used to determine an employee success index for a particular employer or particularly system-level job category of an employer. The personality assessment is explicitly contemplated to be an objective personality survey or quiz which could be electronically administered quickly by the server of the present invention to a device of a successful existing or prior employee of the employer. The results of the personality assessments completed by successful employees of the employer could be used in aggregate to render the employee success index for that particular employer and system-level job category. It is likely that the objective personality survey would be administered to successful existing employees at the employer, but it could also be provided to a prior employee who fit within the category of successful employment with the employer.

A candidate compatibility index could also be calculated in accordance with the remainder of the invention and stored in respect of a particular job candidate. The candidate compatibility index is specifically contemplated to be a quantitative measure or plurality of measures which could be used for matching purposes in which would effectively represent the actual personality traits of the candidate which could be matched against the desirable personality traits represented by the employee success index of a particular position, system-level job category of an employer, or employer. The candidate compatibility index or indexes could be the result of direct calculations applied to personality assessment outcomes of the candidate, or could be the result of the application of a machine learning component or function to the personality assessment outcomes of the candidate further supplemented by access to external datasets corresponding to the candidate such as credit history, academic outcomes, social graphs, genetic markers and the like.

System and Architecture Overview:

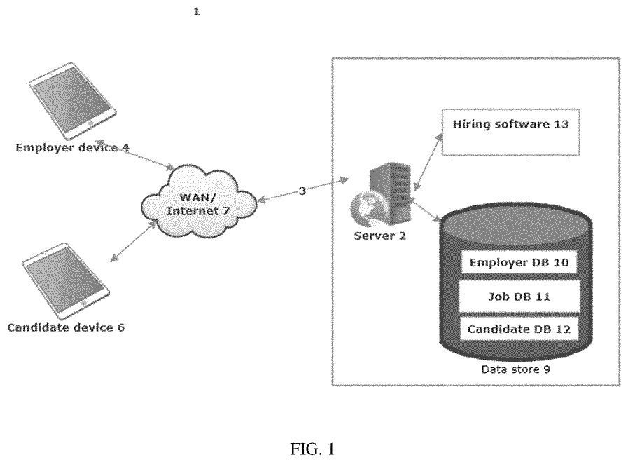

Referring to FIG. 1 there is shown a schematic diagram of the system 1 of the present invention. The system 1 comprises a server 2 having a network interface 3 capable of communication with employer client devices 4, and candidate client devices 6 of job candidates interested in consideration or matching in accordance with the method. The employer client devices 4 and candidate client devices 6 are shown connected to the server 2 via the Internet 7. The server 2 would also include or be operatively connected to a data store 9, capable of hosting or containing a plurality of databases for the practice of the method of the present invention. Shown are the employer database 10, the job database 11, and the candidate database 12. Details of an example of a data structure for these databases are shown in subsequent Figures.

The server 2 also includes a hiring software component 13, operable on the server and capable of executing the steps of the method.

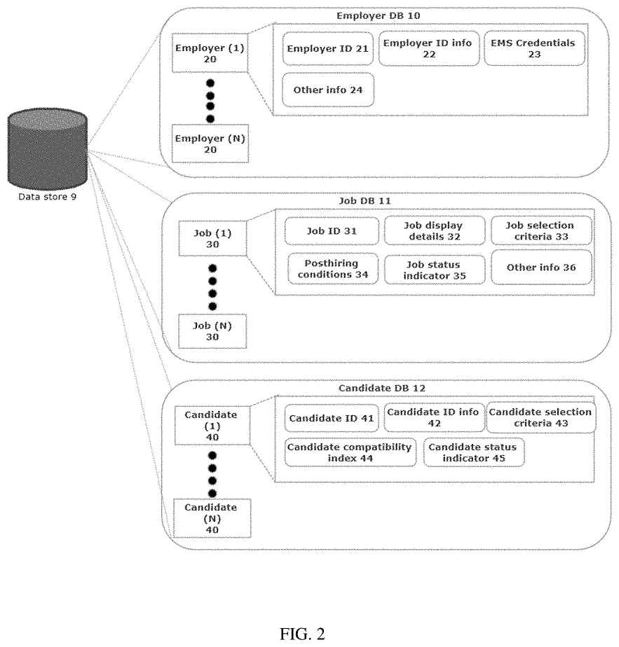

Referring to FIG. 2 there is shown a sample of a data structure for the data store 9 and the employer database 10, job database 11 and candidate database 12. Each of these three databases 10, 11, 12 are shown in this Figure. As will be obvious to those skilled in the art other types of data structures could also be used in which each of the three databases 10, 11 and 12 could be data residing within a single database structure. Either a single consolidated dataset for individual or silo databases will be understood to be within the intended scope of the present invention.

The employer database 10 consists of a plurality (N) of employer records 20, corresponding to each employer using the system and method of the present invention. Each employer record 20 includes the necessary fields or data to practice the method—in basic embodiments, the employer record 20 would include a serial key or employer identifier 21 and any employer identifying information 22. In the embodiment shown there are also any necessary credentials 23 or other information required to allow the server 2 to authenticate and communicate with the employee management system 8 of the corresponding employer. It will be understood to those skilled in the art of database design and the design and execution of various hiring and the system method such as that outlined herein that additional functionality could be added to the system and method of the present invention that might require the storage of additional employer related information in the employer database 10, and the data structure of each employer record 20 could be modified accordingly and is contemplated with any such modification to remain within the scope of the invention as described and claimed herein.

The job database 11 consists of a plurality (N) of job records 30, each of which corresponds to a job offered for matching and hiring purposes by an employer in accordance with the remainder of the present invention. Each job record 30 includes the necessary fields or data to permit display of relevant information for display to job candidates considering the offering of such position as well as the necessary additional information for the purpose of matching candidates to the related job. In the embodiment shown, the job record 30 includes a serial key or job identifier 31, as well as a relational database key 21 back to the corresponding employer record 20. Additionally, the job record 30 as indicated will contain any necessary information 32 for display to candidates in the offer of the related job. Also shown are data structures for the storage of job selection criteria 33, used to match candidates to the related job.

The job record 30 also includes details of any post hiring conditions 34 which must be verified or cleared in respect of the candidate following hiring for the position question. Finally in the data structure shown, the job record 30 also includes a job status indicator 35, indicating the open or completed status of hiring for the job in question. The job record 30 might also include a number of other different fields or information 36 required for the facilitation of the method of the present invention, including keys for matching the job record 30 back to a particular category of positions listed in the employee management system of the associate employer, stored calculated versions of an employee success index calculated in respect of the particular job record 30 in the underlying position, or other information as might be required in the execution of various embodiments of the system of the present invention and all such information will be understood to be within the scope hereof.

The candidate database 12 would consist of a plurality of candidate records 40 each of which corresponded to a particular candidate seeking hiring in accordance with the method of the present invention. The candidate record 40 would include in this embodiment a serial identifier 41, candidate identifying information 42 which could be stored for the purpose of passing on to the employee management system of a employer where a successful manager hire was completed, as well as candidate selection criteria 43, namely details of the selection qualifications possessed by the candidate which can be used for matching purposes. In the embodiment shown there is also a data structure for the storage of a candidate compatibility Index 44, as well as a candidate status indicator 45 which indicates the available or hired status of the candidate in question in accordance with the remainder of the method.

Server:

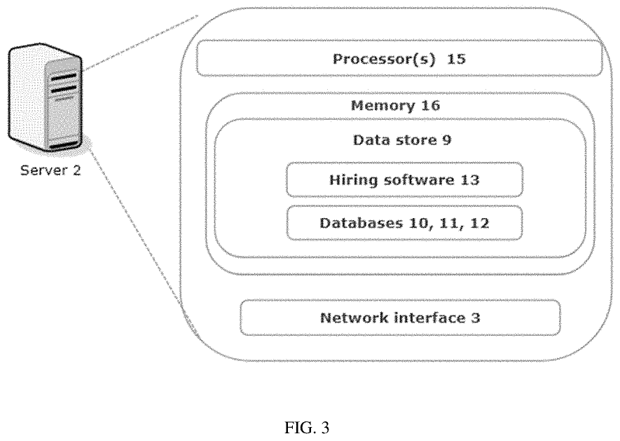

FIG. 3 shows one embodiment of the server 2 in accordance with the present invention. The server 2 might consist of one or more servers 2—a single server or a server farm approach. The server 2 would comprise one or more processors 15 and memory 16. The memory 16 might contain various software components or a series of processor instructions for use in the method of the present invention or otherwise in the operation of the server 2. Processor instructions corresponding to the hiring software component are shown stored within the memory 16 in this Figure.

Memory 16 may comprise non-transitory storage media that electronically stores information. The electronic storage media of memory 16 may include one or both of system storage that is provided integrally (i.e., substantially non-removable) with server(s) 1 and/or removable storage that is removably connectable to server(s) 1 via, for example, a port (e.g., a USB port, a firewire port, etc.) or a drive (e.g., a disc drive, etc.). Memory 16 may include one or more of optically readable storage media (e.g., optical discs, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Memory 16 may include one or more virtual storage resources (e.g., cloud storage, a virtual private network, and/or other virtual storage resources). Memory 16 may store software algorithms, information determined by processor(s) 15, information received from server(s) 2, information received from client devices, and/or other information that enables server(s) 2 to function as described herein.

Processor(s) 15 may be configured to provide information processing capabilities in server(s) 2. As such, processor(s) 15 may include one or more of a digital processor, an analogue processor, a digital circuit designed to process information, an analogue circuit designed to process information, a state machine, and/or other mechanisms for electronically processing information. In some implementations, processor(s) 15 may include a plurality of processing units. These processing units may be physically located within the same device, or processor(s) 15 may represent processing functionality of a plurality of devices operating in coordination.

Server 2 would also include at least one network interface 3 via which it could communicate with the at least one communications network for the purpose of enabling communication with the client devices and employee management systems of the remainder of the method as outlined herein. It will be understood by those skilled in the art of network design and hardware and software design that certain server architectures might include more than one network interface 3 and any type of a server 2 and network interface 3 design which enabled the communication of the server 2 as outlined in the remainder of the method would all be contemplated within the scope of the present invention.

Hiring Software Component:

Functions of the hiring software component 13 would include the creation, administration and maintenance of database records within the databases 10, 11, 12, along with interacting with client devices as required for the purpose of facilitating the method. The hiring software component 13 could also encompass any additional required querying, reporting or added software functionality.

The hiring software component 13 will comprise any compiled processor instructions capable of being executed by the processor of the server 2. It will be understood that any hiring software component 13 having the effect of being able to administer the method of the present invention as outlined is contemplated within the scope of the present invention.

Method Overview:

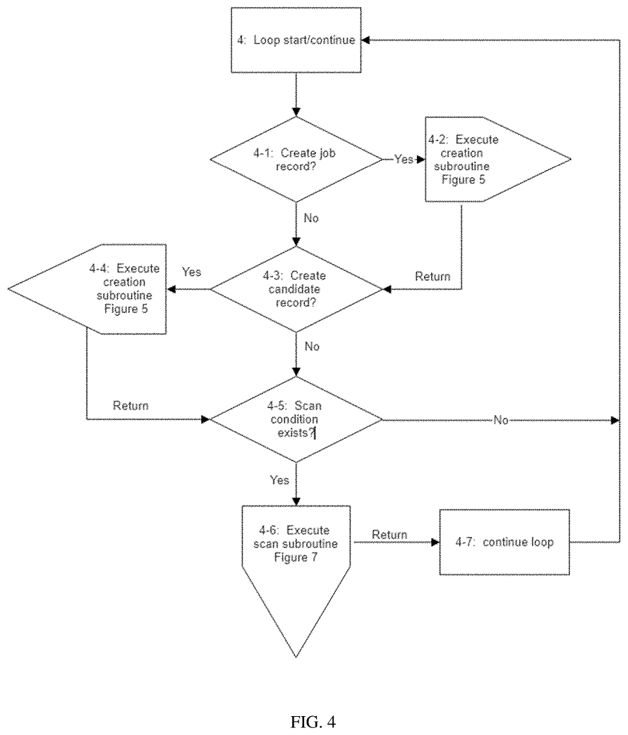

FIG. 4 is a flowchart demonstrating the steps of the first embodiment of the method of the present invention, in which job candidates can be automatically matched with available employer job positions and can accept an offered job with a simple user interface interaction. The method, as executed by the hiring software component 13 in accordance with the remainder of the system of FIGS. 1 to 3, would as demonstrated be conducted in a perpetual loop fashion, although it will be understood to those skilled in the art of software design that there are many different orderings or approaches to the steps in the method as outlined which would still achieve the same objective and would not depart from the intended scope claimed herein.

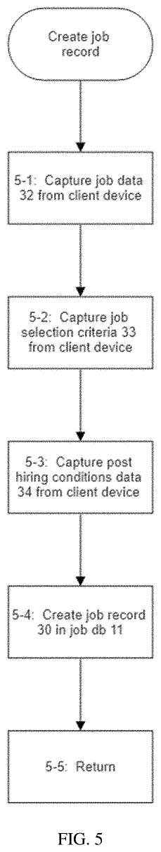

The method shown in this Figure is a listener/repeat loop. Upon initiation of a communication session or interaction for the creation of a job record 30, or receipt of indication from a client device indicating a desire to create a job record, a job record creation subroutine is executed before returning to the primary repeat or monitoring loop. Detection of the condition requiring the creation of a job record is shown at step 4-1, and the triggering of the off page execution of the creation subroutine of FIG. 5 is shown at step 4-2.

In the creation of a job record as outlined in the job record creation subroutine of FIG. 5, an authenticated employer client device could interact and transmit job data to the server 2 including at least any necessary information 32 for display to candidates in the offer of the related job. The capture of job data 32 from the client device is shown at step 5-1. Along with job data 32, the server could also capture job selection criteria 33 and details of any post hiring conditions 34 which must be verified or cleared in respect of the candidate following hiring for the position question. Capture of the job selection criteria 33 and post hiring condition data 34 if any is shown at steps 5-2 and 5-3. Following the capture of all the necessary information from the client device of the employer, the software can create the job record 30 corresponding to the position in the job database 11, as shown at step 5-4. Control would then be returned to the main method and routine of FIG. 4 as the embodiment demonstrates.

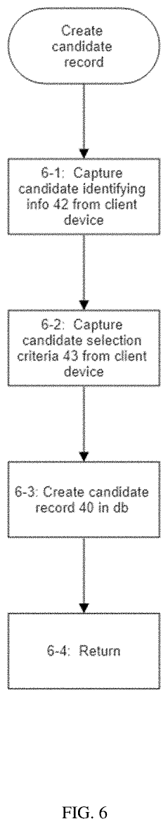

Shown next at 4-3 is another listener/decision block regarding the indication of requirement to create a candidate record 40 within the candidate database 12. Upon initiation of a communication session or interaction for the creation of a candidate record 40, or receipt of indication from a candidate client device indicating a desire to create a candidate record 40—the off page execution of the creation subroutine of FIG. 6 is shown at step 4-4.

In the candidate record creation subroutine of FIG. 6, a candidate client device could interact and transmit candidate data to the server 2 including candidate identifying information 42 which could be stored for the purpose of passing on to the employee management system of a employer where a successful manager hire was completed (Step 6-1), as well as candidate selection criteria 43, namely details of the selection qualifications possessed by the candidate which can be used for matching purposes (Step 6-2). Following the receipt of the candidate data at the server 2 from the candidate client device, the server 2 would create and store a candidate record 40, shown at 6-3—return control after the subroutine to FIG. 4.

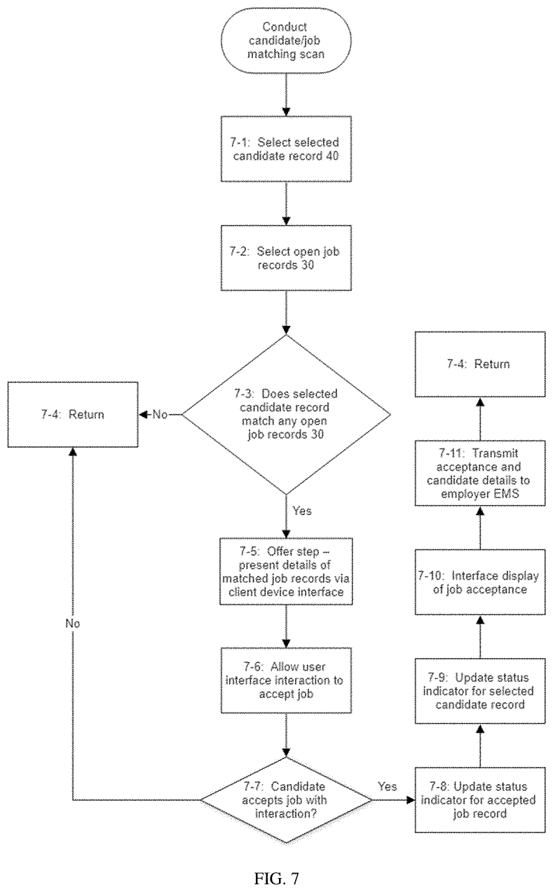

Shown next step 4-5 is a listener seeking to detect the existence of a scan condition in respect of a selected candidate record having an open candidate status indicator. As outlined elsewhere herein, a scan condition could be any preprogrammed or detected condition resulting in a desire on the part of the software component 13 to conduct a matching scan of the databases in question to ascertain whether there are any matchable open jobs for a selected candidate having the open candidate status indicator. As shown, if the existence of a scan condition is detected a matching subroutine or matching step would be conducted. Conduct of the matching subroutine, shown in FIG. 7, is shown at step 4-6. Following the completion of the matching subroutine of FIG. 7, or where no scan condition is detected, the loop of FIG. 4 continues.

Looking at the matching subroutine of FIG. 7, the matching step which is conducted on the detection of the existence of a scan condition consists of, using the hiring software component 13, first confirming or selecting a selected candidate record 40 in respect of which the matching subroutine should be executed. This is shown at step 7-1. The next step is to select any job records 30 with an open status, being open job records, from the job database (shown at 7-2). Matching the selected candidate record 40 against the open job records 30 consists of seeking to match the candidate selection criteria 43 of the selected candidate record 40 with the job selection criteria 33 of the corresponding open job records 30, wherein if a match exists, each matching job record 30 is a matched job record. This first level qualification or matching step is shown at step 7-3. If there are no matched job records, the subroutine would return control to the main method, shown at step 7-4. There are a number of different mathematical or programmatic matching approaches which can be taken in the matching of job selection criteria 33 and candidate selection criteria 43—for example if a standardized structure for the capture of the job selection criteria 33 and candidate selection criterion 43 consists of data entry from system standardized pick list etc. determining a match between jobs and candidates will be very simple in matching those items. In other cases, where free-form data entry is used for particular quantitative or qualitative values for the job selection criteria 33 or candidate selection criteria 43, the software component 13 could match these values by numerical or qualitative comparison to either determine a direct match or in other cases the employer in creation of a particular job record 30 could specify a particular threshold of equivalence above which the system was authorized to offer a position on the basis of being a matched job. Any such approaches are contemplated within the scope of the present invention. It is also the case that certain embodiments of the system might conduct a scan of the entire group of available candidate records 40 in the candidate database upon the existence of a systemwide scan condition, triggered by a particular employer or otherwise. Modifications to the database approach outlined herein to achieve the result of conducting a comparison of the complete contents of open records in the candidate database two available job records will be understood to those skilled in the art and is also contemplated within the scope hereof.

If there is at least one matched job record 30, an offer step is conducted which comprises an unattended offer of employment of any one of the jobs corresponding to the matched job records, to the selected candidate by presenting to a user interface of a candidate client device of the candidate corresponding to the selected candidate record the details 32 of each matched job corresponding to each matched job record. Display of the corresponding jobs being offered, to the user interface of the candidate client device of the candidate, is shown at step 7-5.

The candidate can accept one of the matched job is displayed, by engaging in a user interface interaction with the candidate client device (step 7-6/7-7). If the candidate accepts one of the matched jobs corresponding to the matched job records by an accepting user interface interaction, job acceptance steps will be facilitated by the software component 13 by first updating the job status indicator of the corresponding job record 30 to indicate that the corresponding jobs no longer available for hiring (Step 7-8), as well as optionally updating the candidate status indicator of the corresponding candidate record 40 to indicate the hired status of the candidate being no longer available for hiring (Step 7-9)—in cases where this was a specified desire by the candidate or otherwise specified by the system. In some cases as outlined, the system may specifically contemplated and accommodate hiring of a single candidate into multiple jobs of one or more employers.

The software component 13 will then facilitate the provision of a user interface communication to the candidate client device of the selected candidate, confirming acceptance of the job subject to any post hiring conditions outlined in the corresponding job record 30, shown at 7-10. Finally, the server 2 will transmit the details of the corresponding candidate record 40 and the related job acceptance to the associated employer, for completion of employee finalization and condition clearance and initiation of any other employee onboarding process, shown at 7-11. The method effectively facilitates the hiring of employees without human intervention by the employer from the completion of listing of the job to the completion of job acceptance. Return of control is then returned to the primary method of FIG. 4.

Scan Condition:

As outlined, a scan condition pursuant to which a scanning pass of the job database to ascertain any matches with a particular candidate record could be initiated as a part of a preprogrammed periodic monitoring process, could be requested to be initiated by manual interaction by the candidate subject of the candidate record or by an employer, or scan conditions could also be programmed to exist to periodically conduct the matching step in respect of every active candidate record in the candidate database. There may also be certain embodiments of the method of the present invention where an employer could request the initiation of a systemwide scan condition. All such approaches are contemplated within the scope of the present invention.

User Interface Interaction:

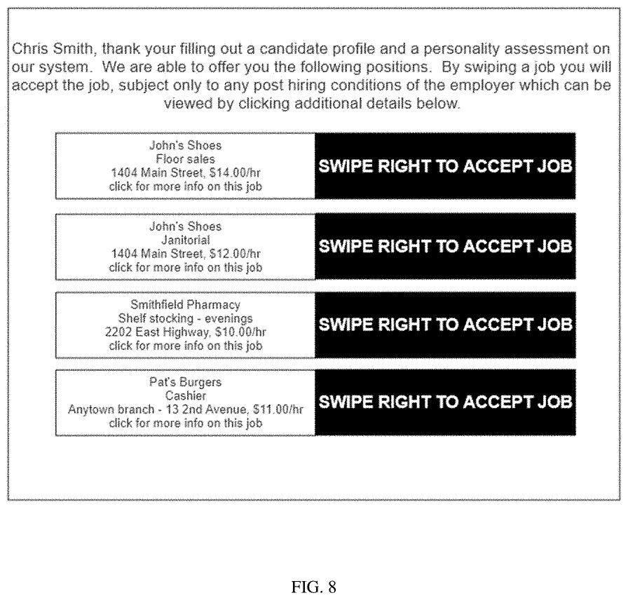

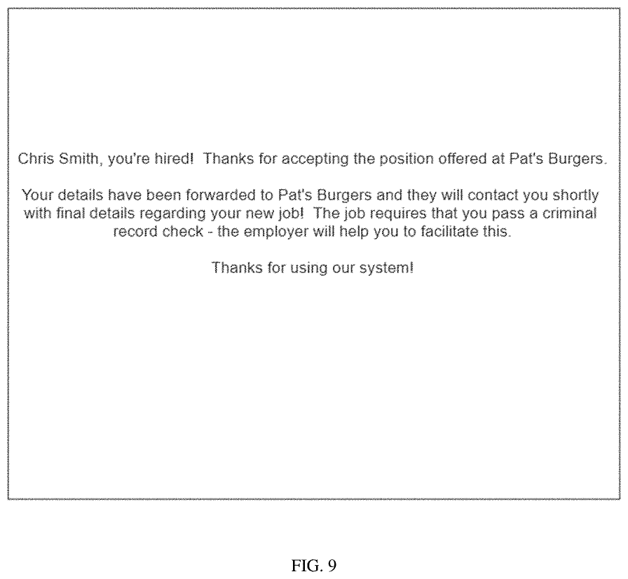

As outlined it is contemplated the majority of the devices which candidates would use to interact with the system of the present invention will be mobile devices such as smart phones, tablets and the like. These all have a touchscreen interface typically and it is explicitly contemplated that the most desirable embodiments of the system of the present invention could provide for a simplified single touch or single step user interface interaction by the candidate with their device to accept the position—for example “swiping” to accept a particular job etc. It will be understood that any type of user interface interaction that has the effect of communicating the intention of the candidate to accept a particular job offered to them by the system are all contemplated within the scope of the present invention. FIG. 8 is a demonstrative screenshot showing sample of an interface that might be presented to a candidate displaying to them the details of matched jobs for offer, including an indication of user problem outlining the nature of the user interface interaction which is required to accept the job i.e. “swipe right to hire”. Also shown in FIG. 9 is a sample of a confirmation display which might be rendered to the candidate device operatively connected to the server upon acceptance of the position.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A computer-implemented automated hiring method whereby employers can automate the hiring of compatible candidates for available jobs, said method comprising:
a. providing a system comprising:
i. a server having:
1. a processor and memory;
2. a network interface capable of communication with client devices of employers and candidates;
3. an employer database comprising an employer record for each employer using the method, each employer record including employer identification information of the employer;
4. a job database comprising a job record corresponding to each job to be filled using the method, each job record comprising:
a. a connection to an employer record in the employer database;
b. at least one job selection criteria for the job, being selection criteria which successful candidates for the corresponding job must possess in order to be qualified for selection by the employer for the corresponding job;
c. indication of any post-hiring conditions which will be required to be verified in respect of a successful candidate following acceptance of an automatically offered job in accordance with the method; and
d. a job status indicator indicating the open or completed status of hiring for the job;
5. a candidate database comprising a candidate record corresponding to each candidate and which can be used for matching and hiring in accordance with the method, each candidate record comprising:
a. candidate selection criteria, representing selection qualifications possessed by the candidate; and
b. a candidate status indicator indicating the available or hired status for the candidate in accordance with the method;
ii. a hiring software component operable on the server and capable of executing the steps of the method;
b. using the system:
i. as required, creating a job record in the job database for each job of an employer for whom a candidate is desired to be hired by:
1. capturing job data from an employer client device in communication with the server including at least:
a. job identifying information;
b. employer identifying information by which the job record can be associated with a linked employer and linked employer record; and
c. any job selection criteria of the job; and
2. creating a job record using the captured job data including setting the job status indicator as open to indicate the associated job is available for hiring;
ii. as required, creating a candidate record in the candidate database for each new job candidate seeking employment through the method by:
1. capturing candidate data from a candidate client device in communication with the server including at least candidate identifying information and candidate selection criteria of the candidate; and
2. creating a candidate record using the captured candidate data, including setting the candidate status indicator indicating the available status of the associated candidate for hiring;
iii. conducting a matching step on detection of the existence of a scan condition in respect of at least one selected candidate record having an available candidate status indicator by, in respect of each at least one selected candidate record:
1. selecting any job records with an open status, being open job records, from the job database;
2. matching the selected candidate record against the open job records by seeking to match the candidate selection criteria of the selected candidate record with the job selection criteria of each open job record, each matched open job record being a matched job record;
3. if there is at least one matched job record, facilitating an unattended offer of employment of any one of the matched jobs corresponding to the matched job records to the selected candidate in an offer step by:
a. presenting to a user interface of a candidate client device the details of the matched jobs; and
b. permitting the candidate to accept one of the matched jobs by a user interface interaction via the interface of the candidate client device;
4. if the candidate accepts a matched job by a user interface interaction:
a. updating the job status indicator of the corresponding job record to indicate that the job is no longer available for hiring;
b. based upon data having been received from the candidate optionally updating the candidate status indicator of the corresponding candidate record to indicate that the selected candidate is no longer seeking employment;
c. providing a user interface communication to the selected candidate confirming the details of the accepted job subject to the post-hiring conditions outlined in the corresponding matched job record; and
d. transmitting the details of the corresponding candidate record and matched job acceptance to the associated employer for completion of the employee finalization and onboarding process including clearance of any post-hiring conditions outlined in the job record;
wherein:
a) the hiring of employees in accordance with the method takes place without user interaction or additional intervention on the part of the employer during hiring;
b) the matching and subsequent user interface interaction accepting the job in all respects constitutes the formal receipt and acceptance of an offer of employment subject only to post-hiring validation of the prescribed post-hiring conditions by the employer; and
c) wherein the user interface interaction used by the candidate to accept a matched job comprises a single interaction by the user with a human interface of the candidate client device.

2. The method of claim 1 wherein the user interface interaction to accept an offered job comprises:
a. the human interface of the candidate client device comprises a touch interface and the user interface interaction comprises a single swiping motion on the touch interface; or
b. the human interface of the candidate client device comprises a display and associated human interaction device and the user interface interaction comprises selecting the desired job to be accepted, if any, using the human interaction device and making a confirmation indication of acceptance.

3. The method of claim 2 wherein the confirmation indication of acceptance is selected from the group of:
a. a single interface click or swipe on the interface of the candidate client device indicating acceptance of the selected job; or
b. application of an automated acceptance of a matched position for a candidate, based on a candidate presetting an acceptance threshold in respect of their candidate record, whereby a matched position would be automatically accepted on detection.

4. The method of claim 1 wherein the candidate selection criteria stored in a candidate record are selected from the group of:
a. desired location of employment;
b. physical attributes of the candidate for consideration in hiring for a manual labour job; or
c. certifications or licenses held by the candidate.

5. The method of claim 1 wherein the at least one job selection criteria are selected from the group of:
a. age requirement of the candidate;
b. employer location of the job;
c. physical requirements of a successful candidate for hiring in a manual labour job; or
d. certification or licensing requirements of a successful candidate.

6. The method of claim 1 wherein the post-hiring conditions required to be verified in respect of the successful candidate are selected from the list of:
a. successful completion of a criminal record or background check of the successful candidate; or
b. successful verification of certification or licensing requirements of the successful candidate.

7. The method of claim 1 wherein the network is the Internet, the server is a Web server, and the client devices are mobile or remote devices operatively connected to the network and capable of communicating with the server via a web interface served therefrom.

8. The method of claim 1 wherein the number of employer records is more than one, resulting in the offer of a service bureau to multiple employers and the ability to offer jobs from multiple employers to a particular selected candidate.

9. A system to be used in the computer-implemented hiring of employees whereby employers can automate the hiring of compatible candidates for available jobs, said system comprising:
a. a server having:
i. a processor and memory;
ii. a network interface capable of communication with client devices of employers and candidates;
iii. an employer database comprising an employer record for each employer using the method, each employer record including employer identification information of the employer;
iv. a job database comprising a job record corresponding to each job to be filled using the method, each job record comprising:
1. a connection to an employer record in the employer database;
2. at least one job selection criteria for the job, being selection criteria which successful candidates for the corresponding job must possess in order to be qualified for selection by the employer for the corresponding job;
3. indication of any post-hiring conditions which will be required to be verified in respect of a successful candidate following acceptance of an automatically offered job in accordance with the method; and
4. a job status indicator indicating the open or completed status of hiring for the job;
v. a candidate database comprising a candidate record corresponding to each candidate and which can be used for matching and hiring in accordance with the method, each candidate record comprising:
1. candidate selection criteria, representing selection qualifications possessed by the candidate; and
2. a candidate status indicator indicating the available or hired status for the candidate in accordance with the method;
b. a hiring software component operable on the server and capable of executing the steps of the method;
wherein the system enables the unattended hiring method of the present invention by:
a. as required, creating job records in the job database for each job of an employer for whom a candidate is desired to be hired by:
i. capturing job data from an employer client device in communication with the server including at least:
1. job identifying information;
2. employer identifying information by which the job record can be associated with a linked employer and linked employer record;
3. any job selection criteria of the job; and
ii. creating a job record using the captured job data including setting the job status indicator as open to indicate the associated job is available for hiring;
b. as required, creating candidate records in the candidate database for each new job candidate seeking employment through the method by:
i. capturing candidate data from a candidate client device in communication with the server including at least candidate identifying information and candidate selection criteria of the candidate; and
ii. creating a candidate record using the captured candidate data including setting the candidate status indicator to indicate the available status of the associated candidate for hiring;
c. conducting a matching step on detection of the existence of a scan condition in respect of of at least one selected candidate record having an available candidate status indicator by, in respect of each at least one selected candidate record:
i. selecting any job records with an open status, being open job records, from the job database;
ii. matching the selected candidate record against the open job records by seeking to match the candidate selection criteria of the selected candidate record with the job selection criteria of each open job record, each matched open job record being a matched job record;
iii. if there is at least one matched job record, facilitating an unattended offer of employment of any one of the matched jobs corresponding to the matched job records to the selected candidate in an offer step by:
1. presenting to a user interface of a candidate client device the details of the matched jobs; and
2. permitting the candidate to accept one of the matched jobs by a user interface interaction via the interface of the candidate client device;
iv. if the candidate accepts a matched job by a user interface interaction:
1. updating the job status indicator of the corresponding job record to indicate that the job is no longer available for hiring;
2. based upon data having been received from the candidate optionally updating the candidate status indicator of the corresponding candidate record to indicate that the selected candidate is no longer seeking employment;
3. providing a user interface communication to the selected candidate confirming the details of the accepted job subject to the post-hiring conditions outlined in the corresponding matched job record; and
4. transmitting the details of the corresponding candidate record and matched job acceptance to the associated employer for completion of the employee finalization and onboarding process including clearance of any post-hiring conditions outlined in the job record;
wherein:
a) the hiring of employees in accordance with the method takes place without user interaction or additional intervention on the part of the employer during hiring;
b) the matching and subsequent user interface interaction accepting the job in all respects constitutes the formal receipt and acceptance of an offer of employment subject only to post-hiring validation of the prescribed post-hiring conditions by the employer; and
c) the user interface interaction used by the candidate to accept a matched job comprises a single interaction by the user with a human interface of the candidate client device.

10. The system of claim 9 wherein:
a. the human interface of the candidate client device comprises a touch interface and the user interface interaction comprises a single swiping motion on the touch interface; or
b. the human interface of the candidate client device comprises a display and associated human interaction device and the user interface interaction comprises selecting the desired job to be accepted, if any, using the human interaction device and making a confirmation indication of acceptance.

11. The system of claim 9 wherein the candidate selection criteria stored in a candidate record are selected from the group of:
a. desired location of employment;
b. physical attributes of the candidate for consideration in hiring for a manual labour job; or
c. certifications or licenses held by the candidate.

12. The system of claim 9 wherein the at least one job selection criteria are selected from the group of:
a. age of the candidate;
b. employer location of the job;
c. physical requirements of a successful candidate for hiring in a manual labour job; or
d. certification or licensing requirements of a successful candidate.

13. The system of claim 9 wherein the post-hiring conditions required to be verified in respect of the successful candidate are selected from the list of:
a. successful completion of a criminal record or background check of the successful candidate; or
b. successful verification of certification or licensing requirements of the successful candidate.

14. The system of claim 9 wherein a scan condition is selected from the group of:
a. detection of a particular timed frequency or interval for a scan of available positions for a candidate record to be conducted;
b. receipt of a data transmission at the server from a candidate client device indicating a desire for a scan of available positions to be conducted;
c. receipt of a data transmission at the server from an employer client device indicating a desire for a scan of available candidates for one or more open job records to be conducted.

15. The system of claim 9 wherein the number of selected candidate records in respect of a desired matching step and scan condition is one.

16. The system of claim 9 wherein the number of selected candidate records in respect of a desired matching step and scan condition is more than one.

17. The system of claim 9 wherein the number of employer records is more than one, resulting in the ability to offer jobs from multiple employers to a particular selected candidate.

18. The system of claim 9 wherein the network is the Internet and the server is a Web server, and the client devices are mobile or remote devices operatively connected to the network and capable of communicating with the server via a web interface served therefrom.
